(19) United States
(12) Patent Application Publication
(10) Pub. No.: US 2024/0144351 A1
(43) Pub. Date: May 2, 2024

(54) METHOD AND SYSTEM FOR PERFORMING CAPACITY PLANNING USING REINFORCEMENT LEARNING

(71) Applicant: Dell Products L.P., Round Rock, TX (US)

(72) Inventors: Priya Shanmugasundaram, Bangalore (IN); Saurabh Jha, Austin, TX (US); Kailash Talreja, Mumbai (IN)

(21) Appl. No.: 17/974,252

(22) Filed: Oct. 26, 2022

(51) Int. Cl. G06Q 30/06

(52) U.S. Cl. CPC G06Q 30/0635

(57) ABSTRACT

Techniques described herein relate to a method for performing capacity planning services. The method includes obtaining a current CP state from a client; in response to obtaining the current state: selecting an action based on the current CP state; providing the action to the client, wherein the client performs the action; in response to providing the action: obtaining a new CP state and a headcount associated with the action; calculating a reward based on the headcount and a reward formula; storing the current CP state, the action, the new CP state, and the reward as a learning set in storage comprising a plurality of learning sets; and performing a learning update using a portion of the plurality of learning sets to generate an updated actor, an updated critic, an updated target actor, and an updated target critic.

### BACKGROUND

Users may submit purchase orders to obtain goods and services from organizations. Organizations may employ user agents to perform purchase order processing. The amount of purchase orders, the amount of user agents, and the user agent working hours may change over time. The organization may require capacity planning services from computing devices to adjust working hours of user agents to meet changes to the amount of purchase orders, the amount of user agents, and the working hours of user agents.

### SUMMARY

In general, certain embodiments described herein relate to a method for performing capacity planning services. The method may include obtaining, by a capacity planning (CP) manager, a current CP state from a client; in response to obtaining the current state: selecting an action based on the current CP state; providing the action to the client, wherein the client performs the action; in response to providing the action: obtaining a new CP state and a headcount associated with the action; calculating a reward based on the headcount and a reward formula; storing the current CP state, the action, the new CP state, and the reward as a learning set in storage comprising a plurality of learning sets; performing a learning update using a portion of the plurality of learning sets to generate an updated actor, an updated critic, an updated target actor, and an updated target critic; selecting a second action based on a second current CP state using the updated actor; and initiating performance of the second action by the client.

In general, certain embodiments described herein relate to a system for performing capacity planning services. The system includes a client and a capacity planning (CP) manager. The CP manager may include a processor and memory, and is programmed to obtain a current CP state from the client; in response to obtaining the current state: select an action based on the current CP state; provide the action to the client, wherein the client performs the action; in response to providing the action: obtain a new CP state and a headcount associated with the action; calculate a reward based on the headcount and a reward formula; store the current CP state, the action, the new CP state, and the reward as a learning set in storage comprising a plurality of learning sets; perform a learning update using a portion of the plurality of learning sets to generate an updated actor, an updated critic, an updated target actor, and an updated target critic; select a second action based on a second current CP state using the updated actor; and initiate performance of the second action by the client.

In general, certain embodiments described herein relate to a non-transitory computer readable medium that includes computer readable program code, which when executed by a computer processor enables the computer processor to perform a method for performing capacity planning services. The method may include obtaining, by a capacity planning (CP) manager, a current CP state from a client; in response to obtaining the current state: selecting an action based on the current CP state; providing the action to the client, wherein the client performs the action; in response to providing the action: obtaining a new CP state and a headcount associated with the action; calculating a reward based on the headcount and a reward formula; storing the current CP state, the action, the new CP state, and the reward as a learning set in storage comprising a plurality of learning sets; performing a learning update using a portion of the plurality of learning sets to generate an updated actor, an updated critic, an updated target actor, and an updated target critic; selecting a second action based on a second current CP state using the updated actor; and initiating performance of the second action by the client.

Other aspects of the embodiments disclosed herein will be apparent from the following description and the appended claims.

### BRIEF DESCRIPTION OF DRAWINGS

Certain embodiments disclosed herein will be described with reference to the accompanying drawings. However, the accompanying drawings illustrate only certain aspects or implementations of the embodiments disclosed herein by way of example and are not meant to limit the scope of the claims.

FIG. 1 shows a diagram of a system in accordance with one or more embodiments disclosed herein.

FIGS. 2A-2B show a flowchart of a method for performing capacity planning services using reinforcement learning in accordance with one or more embodiments disclosed herein.

FIGS. 3A-3B show diagrams of the operation of an example system over time in accordance with one or more embodiments disclosed herein.

FIG. 4 shows a diagram of a computing device in accordance with one or more embodiments disclosed herein.

### DETAILED DESCRIPTION

Specific embodiments will now be described with reference to the accompanying figures. In the following description, numerous details are set forth as examples of the embodiments disclosed herein. It will be understood by those skilled in the art that one or more embodiments disclosed herein may be practiced without these specific details and that numerous variations or modifications may be possible without departing from the scope of the embodiments disclosed herein. Certain details known to those of ordinary skill in the art are omitted to avoid obscuring the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as a and a second element labeled as N. This labeling convention means that the data structure may include any number of the elements. A second data structure, also labeled as A to N, may also include any number of elements. The number of elements of the first data structure and the number of elements of the second data structure may be the same or different.

In general embodiments disclosed herein relate to methods, systems, and non-transitory computer readable mediums for performing capacity planning using reinforcement learning.

In one or more embodiments, organizations may obtain purchase orders from customers specifying products that the customer wishes to purchase and other information associated with the purchase (e.g., a shipping address, a customer identifier, etc.). In order to complete the purchase, the organization may first need to process the purchase order. The organization may include user agents (e.g., employees) that manually process purchase orders for the organization. Organizations may experience fluctuations in the quantities of purchase orders that require processing, the number of user agents working for the organization, and the working hours associated with the user agents. As a result, the organization may experience understaffing Understaffing occurs when the number of user agents working specific working hours is not sufficient to handle a particular load of purchase orders. Understaffing may lead to inefficiencies in purchase order processing, and may result in negative impacts to the business of the organization.

To avoid this, organizations may either hire additional user agents resulting in additional expenses brought upon by the new user agents. Alternatively, the organizations may perform capacity planning to optimize the working hours of the existing user agents to handle the aforementioned fluctuations. For large organizations, with large workforces, processing large quantities of purchase orders, manual capacity planning performed by users (e.g., shift managers) may be grossly inefficient or impossible due to the rapidly changing working environment and large number of variables to assess and adjust. Additionally, it may be impossible for a human worker to manually identify the optimal action to take based on memory alone to adjust user agent working hours to minimize understaffing given certain working environment conditions.

To address this issue, at least in part, embodiments disclosed herein relate to a capacity planning manager that leverages artificial intelligence to perform capacity planning using reinforcement learning. More specifically, the capacity planning manager implements an actor-critic reinforcement learning method that learns over time an optimal action selection policy to use to automatically select actions to adjust working hours of user agents to meet changes in the working environment. The capacity planning manager performs learning update events to update the actor and critic over time to optimize action selection based on the current state of the working environment. As a result, the working hours of user agents may be automatically using actions selected by the capacity planning manager based on the current state of the user agent working environment to minimize understaffing As a result, the efficiency of the organization and the overall purchase order processing performance may be improved and staffing costs may be reduced.

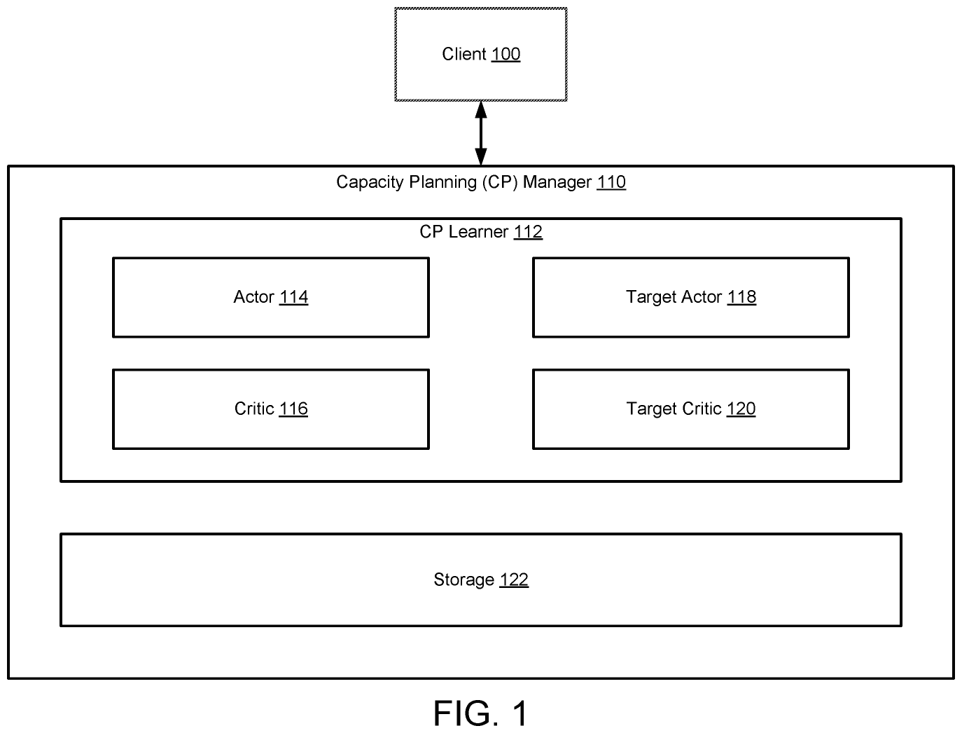

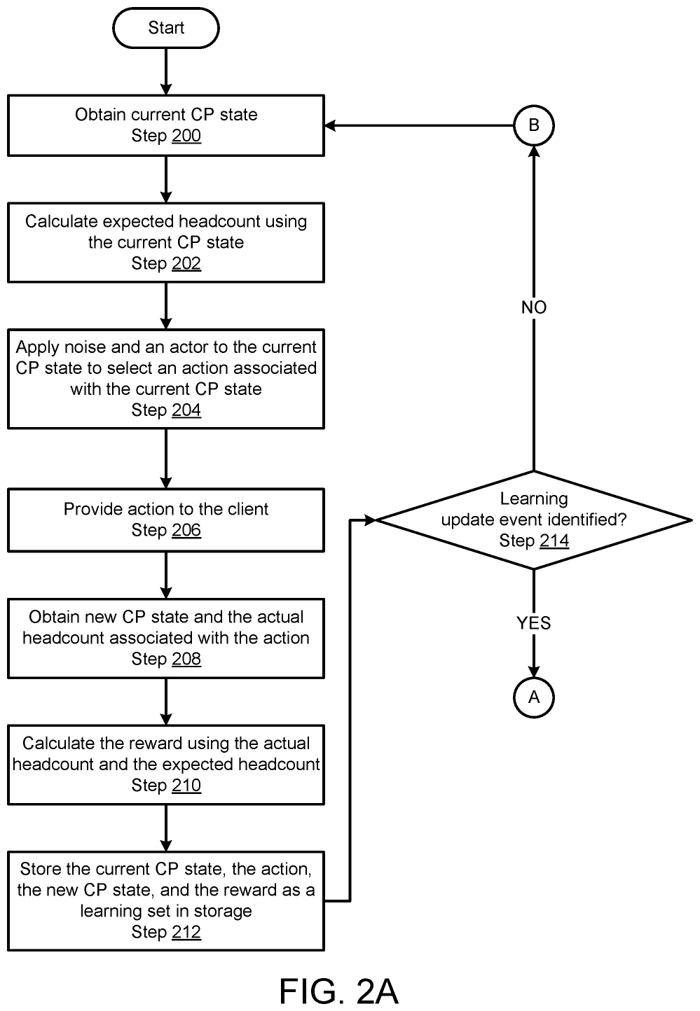

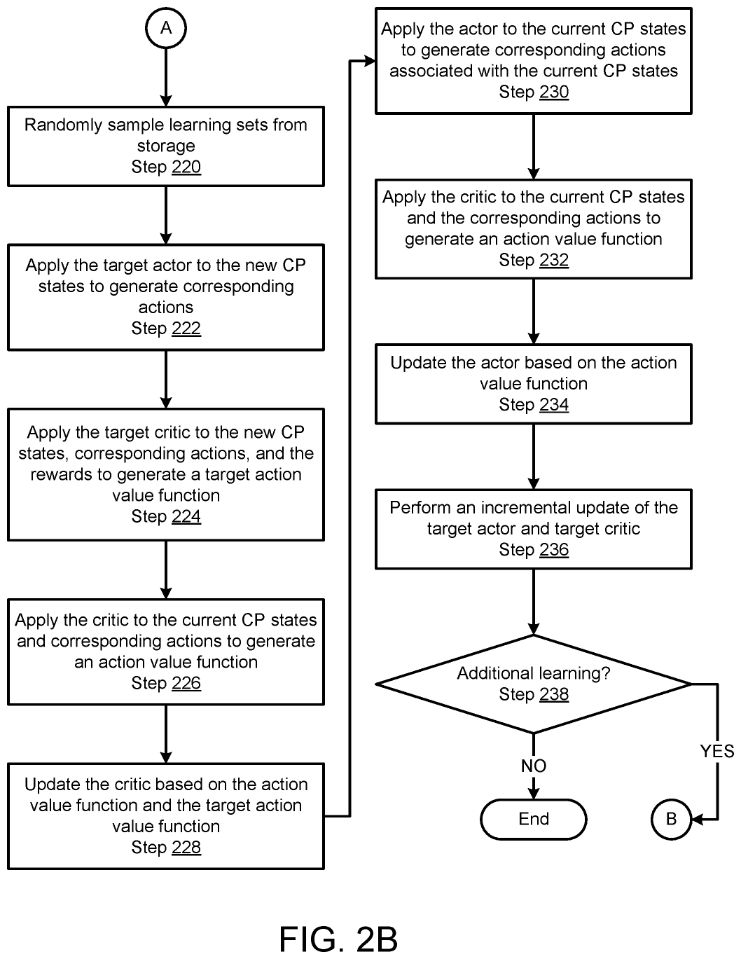

FIG. 1 shows a diagram a system in accordance with one or more embodiments disclosed herein. The system may include a client (100) and a capacity planning (CP) manager (110). The client (100) may provide information associated with CP to the CP manager (110), which in turn provides CP services for the client (100). As used herein, CP services may include optimizing the working hours of user agents (e.g., employees) to perform tasks (e.g., purchase order processing) associated with the client (100) to minimize understaffing which could lead to inefficiencies. For additional information regarding CP services, refer to FIGS. 2A-2B. The components of the system illustrated in FIG. 1 may be operatively connected to each other and/or operatively connected to other entities (not shown) via any combination of wired (e.g., Ethernet) and/or wireless networks (e.g., local area network, wide area network, Internet, etc.) without departing from embodiments disclosed herein. Each component of the system illustrated in FIG. 1A is discussed below.

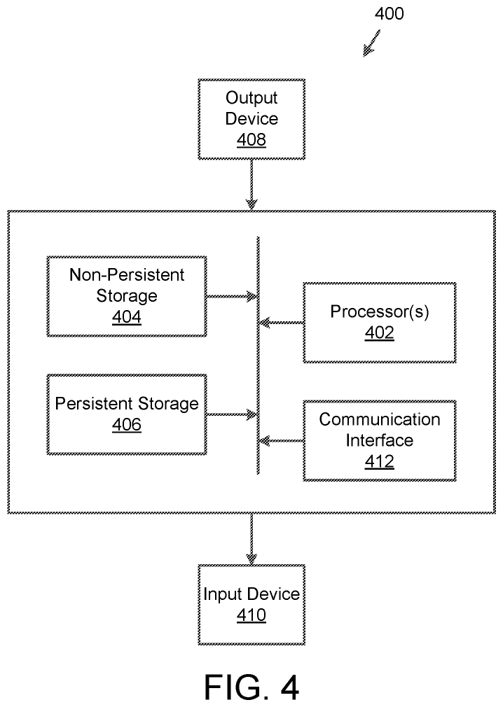

In one or more embodiments, the client (100) may be implemented using one or more computing devices. A computing device may be, for example, mobile phones, tablet computers, laptop computers, desktop computers, servers, or cloud resources. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions described herein and/or all, or a portion, of the methods illustrated in FIGS. 2A-2B. The client (100) may be implemented using other types of computing devices without departing from embodiments disclosed herein. For additional details regarding computing devices, refer to FIG. 4.

In one or more embodiments, the client (100) may be implemented using logical devices without departing from embodiments disclosed herein. For example, the client (100) may include virtual machines that utilize computing resources of any number of physical computing devices to provide the functionality of the client (100). The client (100) may be implemented using other types of logical devices without departing from the embodiments disclosed herein.

In one or more embodiments, the client (100) may include the functionality to, or may be otherwise programmed or configured to, obtain CP services from the CP manager (110). As part of obtaining CP services, the client (100), or users thereof, may provide information associated with current working environment that may be used to take actions to optimize the working hours of the user agents associated with the client (100). In return, the client (100) may obtain actions from the CP manager, that when performed by the client, change the environment in an attempt to optimize the working hours of user agents. The client (100) may include the functionality to perform all, or a portion of, the methods of FIGS. 2A-2B. The client (100) may include other and/or additional functionalities without departing from embodiments disclosed herein.

In one or more embodiments, the CP manager (110) may be implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The persistent storage may store computer instructions, e.g., computer code, that (when executed by the processor(s) of the computing device) cause the computing device to perform the functions of the CP manager (110) described herein and/or all, or a portion, of the methods illustrated in FIGS. 2A-2B. The CP manager (110) may be implemented using other types of computing devices without departing from the embodiments disclosed herein. For additional details regarding computing devices, refer to FIG. 4.

The CP manager (110) may be implemented using logical devices without departing from the embodiments disclosed herein. For example, the CP manager (110) may include virtual machines that utilize computing resources of any number of physical computing devices to provide the functionality of the CP manager (110). The CP manager (110) may be implemented using other types of logical devices without departing from the embodiments disclosed herein.

In one or more embodiments, the CP manager (110) may include the functionality to, or otherwise be programmed or configured to, perform CP services for the client (100). The CP manager (110) may include the functionality to perform all, or a portion of, the methods discussed in FIGS. 2A-2B. The CP manager (110) may include other and/or additional functionalities without departing from embodiments disclosed herein. For additional information regarding the functionality of the CP manager (110), refer to FIGS. 2A-2B.

To perform the aforementioned functionality of the CP manager (110), the CP manager may include a CP learner (112) and storage (122). The CP manager (110) may include other, additional, and/or fewer components without departing from embodiments disclosed herein. Each of the aforementioned components of the CP manager (110) is discussed below.

In one or more embodiments disclosed herein, the CP learner (112) is implemented as a physical device. The physical device may include circuitry. The physical device may be, for example, a field-programmable gate array, application specific integrated circuit, programmable processor, microcontroller, digital signal processor, or other hardware processor. The physical device may be configured to provide the functionality of the CP learner (112) described throughout this Detailed Description.

In one or more embodiments disclosed herein, the CP learner (112) is implemented as computer instructions, e.g., computer code, stored on a storage (e.g., storage (122)) that when executed by a processor of the CP manager (110) causes the CP manager (110) to provide the functionality of the CP learner (112) described throughout this Detailed Description.

In one or more embodiments, the CP learner (112) includes the functionality to, or is otherwise configured to, perform the CP services of the CP manager (110). The CP services performed by the CP learner (112) may include selecting actions based on CP states (discussed below) obtained from the client (100) using one or more models (discussed below), providing actions to the client (100), and updating the models (e.g., learning an optimal selection policy) used for action selection to optimize action selection for a give CP state over time using reinforcement learning. The CP learner (112) may include the functionality to perform all, or a portion thereof, the steps in the methods depicted in FIGS. 2A-2B. The CP learner (112) may include, or be configured to perform, other and/or additional functionalities without departing from embodiments disclosed herein. For additional information regarding the functionality of the CP learner (112), refer to FIGS. 2A-2B.

In one or more embodiments, the CP learner (112) may implement an actor-critic architecture to perform reinforcement learning for the CP services. The actor-critic architecture may include four neural networks, an actor (114), a critic (116), a target actor (118), and a target critic (120). As used herein, a neural network may refer to computer instructions, which when executed by a processor of the CP manager (110), provide the functionality of the neural network.

In one or more embodiments, the actor (114) may include the functionality to select actions for a given CP state. The actor (114) may select actions based on a deterministic action selection policy function approximated by the neural network implemented by the actor (114). In one or more embodiments, the critic (116) may include the functionality to assess state action pairs selected by the actor (114). The critic (116) may include the functionality to assess the state action pairs based on an action value function that specifies the expected reward that may be obtained in the future when the actor selects an action by the selection policy in a particular state.

In one or more embodiments, the actor (114) and the critic (116) are updated over time based on prior learning sets (discussed below) to optimize action selection based on CP states to maximize user agent resource utilization and to minimize understaffing. In one or more embodiments, the actor (114) and the critic (116) are online models. In other words, the actor (114) and critic (116) generate actions given CP states obtained from the client (100) and assess state action pairs respectively. To mitigate non-stationarity and ensure learning stability, a target actor (118) and a target critic (120) are slowly updated based on the actor (114) and critic (116) through incremental updates. The target actor (118) and the target critic (120) may be offline. In other words, the target actor (118) and the target critic (120) may not participate in the state selection and state action pair assessment of the actor (114) and the critic (116), and may only be used during learning updates.

In one or more embodiments, the storage (122) may be implemented using one or more volatile or non-volatile storages or any combination thereof. The storage (122) may include the functionality to, or otherwise be configured to, store and provide information that may be used by the CP manager (110) and the components thereof (e.g., 112, 114, 116, 118, 120) to perform CP services. The information stored in the storage (122) may include learning sets, headcounts, expected headcounts (all discussed below), and other and/or additional information associated with CP services without departing from embodiments disclosed herein.

Although the system of FIG. 1A is shown as having a certain number of components (e.g., 100, 110, 112, 122), in other embodiments disclosed herein, the system may have more or fewer components. For example, the functionality of each component described above may be split across components or combined into a single component. Further still, each component may be utilized multiple times to carry out an iterative learning operation.

FIGS. 2A-2B show flowcharts of a method in accordance with one or more embodiments disclosed herein. The method shown in FIGS. 2A-2B may be performed to perform CP services using reinforcement learning in accordance with one or more embodiments disclosed herein. The method of FIGS. 2A-2B may be performed by, for example, the CP manager (e.g., 110, FIG. 1). Other components of the system illustrated in FIG. 1 may perform all, or a portion, of the method of FIGS. 2A-2B without departing from the scope of the embodiments disclosed herein.

While FIGS. 2A-2B are illustrated as a series of steps, any of the steps may be omitted, performed in a different order, additional steps may be included, and/or any or all of the steps may be performed in a parallel and/or partially overlapping manner without departing from the scope of the embodiments described herein.

Turning to FIG. 2A, at Step 200, a current CP state is obtained. In one or more embodiments, the CP manager obtains a CP state from the client. The client may provide the current CP state to the CP manager using any appropriate method of data transmission without departing from embodiments disclosed herein. For example, the current CP state may be sent as part of a message including multiple network packets through one or more network devices that operatively connect the client to the CP manager. The current CP state may be obtained from the client via other and/or additional methods without departing from embodiments disclosed herein.

In one or more embodiments disclosed herein, the current CP state may refer to one or more data structures that include information specifying the current working hours associated with user agents of the client. The current CP state may be implemented as a feature vector that include the current information associated with one or more user agents of the client for which CP services are performed. The information may include working hours associated with a user agent, the total outage hours associated with a user agent, the shrinkage hours associated with a user agent, the productivity reduction, and the total productive hours associated with a user agent. The information included in the current CP state information may be associated with a weekly basis.

The working hours may specify the number of scheduled working hours plus the number of overtime hours a user agent works in a week. The total outage hours may specify the total number of unplanned outage hours (e.g., unplanned sick leave) and planned outage hours (e.g., vacations, holidays, etc.) a user agent uses in a week. The shrinkage hours specifies the total number of meeting hours (e.g., hours spent in meetings) plus the total number of break hours (e.g., total number of hours spent on break) associated with a user agent in a week. The productivity reduction may specify one minus the dividend of the outage hours and the working hours, all multiplied by the shrinkage hours associated with a user agent. The total productive hours may specify the working hours minus the outage hours minus the productivity reduction associated with a user agent. The current CP state may include other and/or additional information associated with user agents of the client without departing from embodiments disclosed herein. The current CP state may be generated by the client.

In Step 202, the expected headcount is calculated using the current CP state. In one or more embodiments, the CP manager may use the current CP state to calculate the expected headcount. In one or more embodiments, the CP manager may obtain other headcount information from the client to calculate the expected headcount. The headcount information may include the average handling time associated with a purchase order by a single user agent (e.g., the average amount of time it takes a user agent to process a purchase order) and the expected quantity of incoming orders (e.g., forecasted by the client or other entity not shown in FIG. 1). The CP manager may then calculate the expected headcount based on the current CP state information, the average handling time, and the expected quantity of incoming orders. The expected headcount specifies the expected number of user agents required to process the expected quantity of purchase orders over a given period of time given the average handling time and the current CP state. The expected headcount may be calculated using the current CP state via other and/or additional methods without departing from embodiments disclosed herein.

In Step 204, noise and the actor are applied to the current CP state to select an action associated with the current CP state. In one or more embodiments, the CP learner of the CP manager may apply noise and the actor and the current CP state. The actor may use an action selection policy to select an action given the current CP state. The noise may cause the actor to deviate from the action selection policy to select an action that it would otherwise not select without the noise to encourage exploration by the actor to maximize optimization. The noise may include, for example, Ornstein-Uhlenbeck noise. The noise may include other and/or additional types of noise (e.g., Gaussian noise) without departing from embodiments disclosed herein. Noise and the actor may be applied to the current CP state to select an action associated with current CP state via other and/or additional methods without departing from embodiments disclosed herein.

In one or more embodiments, the action may refer to one or more data structures that specify changes to a portion of the state information associated with the user agents. The action may include changes to the overtime hours, the meeting hours, and planned outage hours, and/or the unplanned outage hours associated with the user agents. The action may result in an increase or a decrease in the aforementioned parameters. Each parameter (e.g., overtime hours, meeting hours, planned outage hours, and unplanned outage hours) may include modification thresholds that set a minimum allowable value and a maximum allowable parameter value in order to maintain reasonable working conditions for the user agents. The modification thresholds may be the same or different for each parameter. For example, the modification thresholds for overtime hours may be between zero and four hours while the modification threshold for meeting hours may be between zero and five hours. The modification thresholds may be configurable by a user of the CP manager.

In Step 206, the action is provided to the client. In one or more embodiments, the CP manager provides the action to the client using any appropriate method of data transmission without departing from embodiments disclosed herein. For example, the current CP state may be sent as part of a message including multiple network packets through one or more network devices that operatively connect the client to the CP manager. In one or more embodiments, in response to obtaining the action, the client adjusts the overtime hours, meeting hours, planned outage hours, and unplanned outage hours associated with the user agents as specified by the action. The current CP state may be obtained from the client via other and/or additional methods without departing from embodiments disclosed herein.

In Step 208, a new CP state and an actual headcount associated with the action are obtained. In one or more embodiments, in response to performing the action, the CP state changes and the expected orders associated with that state are processed. The client generates a new CP state including information associated with the new working parameters associated with the user agents and an actual headcount required to process the purchase orders following implementation of the action. The client then sends the new CP state and the actual headcount associated with the action to the CP manager using any appropriate method of data transmission. For example, the new CP state and the actual headcount may be sent as part of a message including multiple network packets through one or more network devices that operatively connect the client to the CP manager. The new CP state and an actual headcount associated with the action may be obtained via other and/or additional methods without departing from embodiments disclosed herein.

In Step 210, the reward is calculated using the actual headcount and the expected headcount. In one or more embodiments, the CP manager calculates the reward using the actual headcount and the variance headcount and a reward function. The CP manager may generate the variance headcount by subtracting the expected headcount from the actual headcount. The reward function may specify that if the variance headcount is positive (e.g., more user agents than required based on the user agents' working parameters) or zero (e.g., the user agents and the associated working parameters matched the actual headcount), then the CP manager generates a reward of zero. The reward function may further specify that if the variance headcount is negative, (e.g., less user agents than required based on the user agents' working parameters resulting in understaffed conditions), then the CP manager uses the value of the variance headcount as the reward. The CP manager attempts to maximize the reward. Therefore, over time, as the action selection policy is optimized, the variance headcount will approach zero. In one or more embodiments disclosed herein, the reward function is configurable. In other words, reward function may be adjusted (e.g., doubling the negative variance headcount value, adding a negative constant to the negative variance headcount, etc.) to minimize the number of learning cycles required to obtain the optimal action selection policy. The reward may be calculated using the actual headcount and the expected headcount via other and/or additional methods without departing from embodiments disclosed herein.

In Step 212, the current CP state, the action, the new CP state, and the reward are stored in storage as a learning set. In one or more embodiments, the CP manager may store the current CP state, the action, the new CP state, and the reward as a learning set in a storage that includes previously generated learning sets. In one or more embodiments, the learning sets may be used by the CP learner to update the actor, the critic, the target actor, and the target critic during learning update events.

In Step 214, a determination is made as to whether a learning update event is identified. In one or more embodiments disclosed herein, the CP manager may repeat Step 200 through 212 to iteratively select actions for current CP states, obtain corresponding new CP states, and generate corresponding rewards associated with the actions for a configurable number of cycles before performing a learning update to update the actor, the critic, the target actor, and the target critic. The CP manager may keep track of the number of cycles performed by the CP learner since the previous learning update. In one or more embodiments, if the number of cycles is less than the configurable number of cycles, then the CP manager may determine that a learning update event is not identified. In one or more embodiments, if the number of cycles is matches the configurable number of cycles, then the CP manager may determine that a learning update event is identified. A determination as to whether a learning update event is identified may be made via other and/or additional methods without departing from embodiments disclosed herein.

In one or more embodiments disclosed herein, if it is determined that a learning update event is identified, then the method proceeds to Step 220 of FIG. 2B. The CP manager may also reset the count of cycles to zero. In one or more embodiments disclosed herein, if it is determined that a learning update event is not identified, then the method proceeds to Step 200 of FIG. 2A to perform another cycle.

Moving now to FIG. 2B, in Step 220, learning sets are randomly sampled from the storage. In one or more embodiments, the CP learner of the CP manager may randomly select a subset of the learning sets stored in the storage. The subset of learning sets may include any number of learning sets without departing from embodiments disclosed herein. As discussed above, learning sets may include a current CP state, an action selected based on the current CP state, the corresponding reward, and the new CP state. The CP learner may use any appropriate method of random sampling without departing from embodiments disclosed herein. The learning sets may be randomly sampled from the storage via other and/or additional methods without departing from embodiments disclosed herein.

In Step 222, the target actor is applied to the new CP states to generate corresponding actions. In one or more embodiments the CP learner of the CP manager may the target actor to the new CP states of the learning sets to select actions corresponding to the new CP states. The target actor may use a target actor action selection policy to select an action given the current CP state. The actor may be applied to the new CP states to generate corresponding actions via other and/or additional methods without departing from embodiments disclosed herein.

In Step 224, the target critic is applied to the new CP states, corresponding actions, and the rewards to generate a target action value function. In one or more embodiments, the CP learner may apply the target critic to the new CP states, the corresponding actions generated in Step 222, and the rewards included in the subset of learning sets to generate a target action value function. The target critic may be applied to the new CP states, corresponding actions, and the rewards to generate a target action value function via other and/or additional methods without departing from embodiments disclosed herein.

In Step 226, the critic is applied to the current CP states and corresponding actions to generate an action value function. In one or more embodiments, the CP learner may apply the critic to the current CP states and corresponding actions included in the subset of learning sets to generate an action value function. The critic may be applied to the current CP states and corresponding actions to generate an action value function via other and/or additional methods without departing from embodiments disclosed herein.

In Step 228, the critic is updated based on the action value function and the target action value function. In one or more embodiments disclosed herein, the CP learner may generate a cost function using the target action value function and the action value function. The CP learner may update the critic neural network (e.g., by adjusting neural network weights or other neural network parameters associated with the critic) to minimize the cost function. The critic may be updated based on the action value function and the target action value function via other and/or additional methods without departing from embodiments disclosed herein.

In Step 230, the actor is applied to the current CP states to generate corresponding actions associated with the current CP states. In one or more embodiments, the CP learner may apply the actor to the current CP states of the subset of learning sets to select new actions associated with the new CP states based on the current action selection policy of the actor. The actor may be applied to the current CP states to generate corresponding actions associated with the current CP states via other and/or additional methods without departing from embodiments disclosed herein.

In Step 232, the critic is applied to the current CP states and the corresponding actions to generate an action value function. In one or more embodiments, the CP learner may apply the critic to the current CP states and corresponding actions generated in Step 230 to generate an action value function. The critic may be applied to the current CP states and corresponding actions to generate an action value function via other and/or additional methods without departing from embodiments disclosed herein.

In Step 234, the actor is updated based on the action value function. In one or more embodiments disclosed herein, the CP learner may generate a gradient of the action value function. The CP learner may then update the actor neural network (e.g., by adjusting neural network weights or other neural network parameters associated with the actor) based on the direction of the gradient of the action value function. The actor may be updated based on the action value function via other and/or additional methods without departing from embodiments disclosed herein.

In Step 236, an incremental update of the target actor and the target critic is performed. In one or more embodiments disclosed herein, the CP learner may incrementally update the target actor and the target critic using the actor and critic updates and an incremental update parameter. The incremental update parameter may specify a proportion of the updates to the actor and critics to apply to the target actor and the target critic to incrementally update the target actor and the target critic. The incremental update parameter may be configurable by a user of the CP manager. The incremental update of the target actor and the target critic may be performed via other and/or additional methods without departing from embodiments disclosed herein.

In Step 238, a determination is made as to whether there is additional learning. In one or more embodiments, the CP manager may perform a configurable number of learning update events during the learning phase of the CP manager. The CP manager may keep track of the number of learning events performed by the CP learner. In one or more embodiments, if the number of learning events is less than the configurable number of learning events, then the CP manager may determine that there is additional learning. In one or more embodiments, if the number of learning events is matches the configurable number of learning events, then the CP manager may determine that there is no additional learning. The determination as to whether there is additional learning may be made via other and or additional methods without departing from embodiments disclosed herein.

In one or more embodiments disclosed herein, if it is determined that there is additional learning, then the method proceeds to Step 200 of FIG. 2A. In one or more embodiments disclosed herein, if it is determined that there is additional learning, then the method ends following Step 238.

In one or more embodiments, following the learning phase of the CP manager, the CP manager may simply use the final action selection policy of the actor to perform action selections for current CP states obtained from the client. In other words, the CP manager may continuously repeat Steps 200 through 206 of FIG. 2A.

One of ordinary skill in the relevant art will appreciate that embodiments discussed herein may be applied to other optimization problems besides capacity planning. For example, embodiments disclosed herein may be used to optimize computer resource utilization and other and/or additional optimization problems without departing from embodiments disclosed herein.

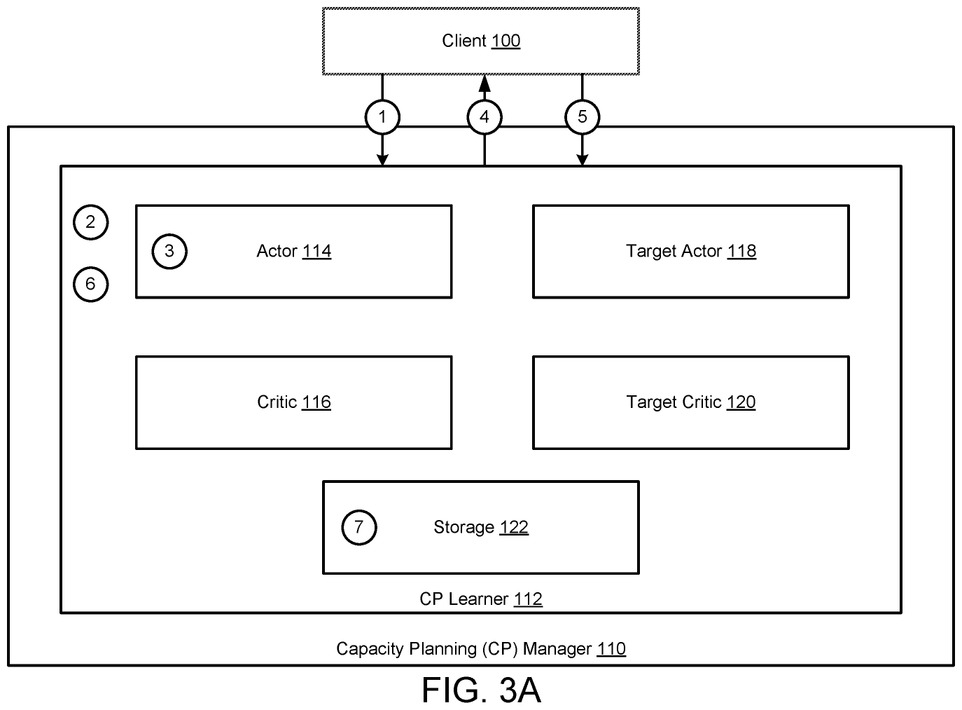

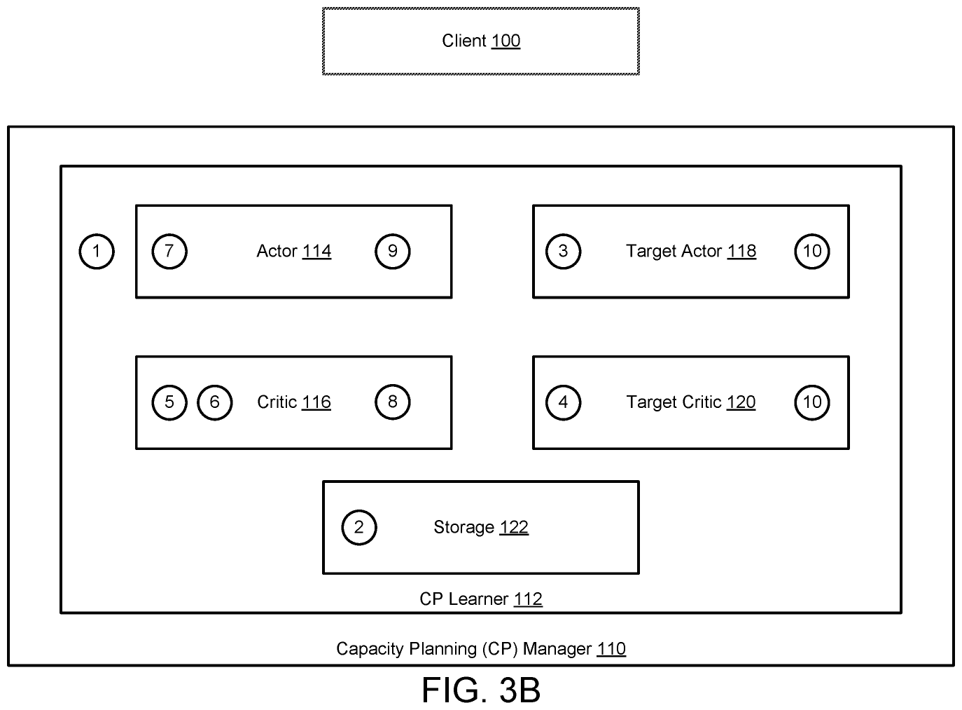

To further clarify embodiments disclosed herein, a non-limiting example is provided in FIGS. 3A-3B. FIGS. 3A-3B show diagrams of the operation of an example system over time in accordance with one or more embodiments disclosed herein. FIGS. 3A-3B show an example system similar to that illustrated in FIG. 1. Actions performed by components of the illustrated system are illustrated by numbered, circular boxes interconnected, in part, using arrowed lines. For the sake of brevity, only a limited number of components of the system of FIG. 1 are illustrated in FIGS. 3A-3B.

### Example

Consider a scenario as illustrated in FIG. 3A in which a client (100), at Step 1, sends a current CP state to a CP manager (110) to obtain CP services from the CP manager. The current CP state specifies that the user agents of the client (100) include 46 hours of total working time, 6 hours of total outage hours, 5 hours of shrinkage hours, a productivity reduction of 4 hours, and 35.5 hours of total productive hours. At Step 2, the CP learner (112) calculates the expected headcount based on the current CP state, the average handling time of purchase orders, and the expected number of purchase orders for the given time period.

At Step 3, the CP learner applies the actor (114) to the current CP state to select and action based on the current action selection policy of the actor (114). The action includes adjusting the overtime hours to 0.5 hours, the meeting hours to 4 hours, the planned outage hours to 2 hours, and the unplanned outage hours to 1 hour. Next, at Step 4, the CP learner (112) provides the action to the client (100), which implements the action. At Step 5, the client (100) provides the next CP state and the actual headcount to the CP learner (112). At Step 6, the CP learner (112) uses the actual headcount, the expected headcount, and the reward function to generate a reward associated with the action and current CP state. Finally, at Step 7, the CP learner (112) stores the current CP state, the action, the reward, and the new CP state in the storage (122) as a learning set.

Turning to FIG. 3B, consider a scenario in which a CP learner (112) of a CP manager (110), at Step 1, identifies a learning update event. In response to identifying the learning update event, at Step 2, CP learner (112) randomly samples the learning sets stored in the storage (122) to obtain a subset of learning sets. Then, at Step 3 the CP learner (112) applies the target actor to the new CP states of the subset of learning sets to generate corresponding actions. Then, at Step 4, the CP learner (112) applies the target critic the new CP states, corresponding actions, and the rewards to generate a target action value function. At Step 5, CP learner (112) applies the critic to the current CP states and corresponding actions of the subset of learning sets to generate an action value function. After that, At Step 6, the CP learner (112) updates the critic based on the action value function and the target action value function.

Next, At Step 7, the CP learner (112) applies the actor to the current CP states of the subset of learning sets to generate new corresponding actions associated with the current CP states. At Step 8, the CP learner (112) applies the critic to the current states and the corresponding actions to generate an action value function. Then, at Step 9, the CP learner (112) updates the actor based on the action value function. Finally, at Step 10, the CP learner (112) performs an incremental update of the target actor and the target critic.

End of Example

As discussed above, embodiments disclosed herein may be implemented using computing devices. FIG. 4 shows a diagram of a computing device in accordance with one or more embodiments disclosed herein. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

As used herein, an entity that is programmed to or configured to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified) to perform the function. An entity that is programmed to perform a function does not include computer instructions in isolation from any hardware devices. Computer instructions may be used to program a hardware device that, when programmed, provides the function.

While the data structures are discussed above as separate data structures and have been discussed as including a limited amount of specific information, any of the aforementioned data structures may be divided into any number of data structures, combined with any number of other data structures, and may include additional, less, and/or different information without departing from embodiments disclosed herein. Additionally, any of the aforementioned data structures may be stored in different locations (e.g., in storage of other computing devices) and/or spanned across any number of computing devices without departing from embodiments disclosed herein. The data structures may be implemented using, for example, lists, linked lists, tables, unstructured data, databases, etc.

The problems discussed above should be understood as being examples of problems solved by embodiments disclosed herein and the embodiments disclosed herein should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments disclosed herein have been described above with respect to a limited number of embodiments, those skilled in the art, having the benefit of this disclosure, will appreciate that other embodiments can be devised which do not depart from the scope of the embodiments disclosed herein as of the embodiments disclosed herein. Accordingly, the scope of the embodiments disclosed herein should be limited only by the attached claims.

What is claimed is:

1. A method for performing capacity planning services, comprising:
obtaining, by a capacity planning (CP) manager, a current CP state from a client;
in response to obtaining the current state:
selecting an action based on the current CP state;
providing the action to the client, wherein the client performs the action;
in response to providing the action:
obtaining a new CP state and a headcount associated with the action;
calculating a reward based on the headcount and a reward formula;
storing the current CP state, the action, the new CP state, and the reward as a learning set in storage comprising a plurality of learning sets;
performing a learning update using a portion of the plurality of learning sets to generate an updated actor, an updated critic, an updated target actor, and an updated target critic;
selecting a second action based on a second current CP state using the updated actor; and
initiating performance of the second action by the client.

2. The method of claim 1, wherein selecting the action based on the current CP state comprises applying noise and the actor to the current CP state.

3. The method of claim 2, wherein performing a learning update using a portion of the plurality of learning sets comprises:
randomly sampling the learning sets to obtain the portion of the learning sets;
updating the critic based on the portion of the learning sets;
updating the actor based on the portion of the learning sets; and
performing an incremental update of the target actor and the target critic.

4. The method of claim 1, wherein the reward formula is configurable.

5. The method of claim 1, wherein reward formula comprises calculating a variance headcount based on the headcount and an expected headcount associated with the current CP state.

6. The method of claim 1, wherein the current CP state comprises at least one of:
first working hours associated with user agents of the client;
first outage hours of the user agents;
first shrinkage hours associated with the user agents;
first reduction in productivity associated with the user agents; and
first productive hours associated with the user agents.

7. The method of claim 6, wherein the action comprises modifying at least one of:
overtime hours associated with the user agents;
meeting hours associated with the user agents;
planned outage hours associated with the user agents; and
unplanned outage hours associated with the user agents.

8. The method of claim 1, wherein the action is limited based on at least one modification threshold.

9. A non-transitory computer readable medium comprising computer readable program code, which when executed by a computer processor enables the computer processor to perform a method for performing capacity planning services, the method comprising:
obtaining, by a capacity planning (CP) manager, a current CP state from a client;
in response to obtaining the current state:
selecting an action based on the current CP state;
providing the action to the client, wherein the client performs the action;
in response to providing the action:
obtaining a new CP state and a headcount associated with the action;
calculating a reward based on the headcount and a reward formula;
storing the current CP state, the action, the new CP state, and the reward as a learning set in storage comprising a plurality of learning sets;
performing a learning update using a portion of the plurality of learning sets to generate an updated actor, an updated critic, an updated target actor, and an updated target critic;
selecting a second action based on a second current CP state using the updated actor; and
initiating performance of the second action by the client.

10. The non-transitory computer readable medium of claim 9, wherein selecting the action based on the current CP state comprises applying noise and the actor to the current CP state.

11. The non-transitory computer readable medium of claim 10, wherein performing a learning update using a portion of the plurality of learning sets comprises:
randomly sampling the learning sets to obtain the portion of the learning sets;
updating the critic based on the portion of the learning sets;
updating the actor based on the portion of the learning sets; and
performing an incremental update of the target actor and the target critic.

12. The non-transitory computer readable medium of claim 9, wherein the reward formula is configurable.

13. The non-transitory computer readable medium of claim 9, wherein reward formula comprises calculating a variance headcount based on the headcount and an expected headcount associated with the current CP state.

14. The non-transitory computer readable medium of claim 9, wherein the current CP state comprises at least one of:
first working hours associated with user agents of the client;
first outage hours of the user agents;
first shrinkage hours associated with the user agents;
first reduction in productivity associated with the user agents; and
first productive hours associated with the user agents.

15. The non-transitory computer readable medium of claim 14, wherein the action comprises modifying at least one of:
overtime hours associated with the user agents;
meeting hours associated with the user agents;
planned outage hours associated with the user agents; and
unplanned outage hours associated with the user agents.

16. The non-transitory computer readable medium of claim 9, wherein the action is limited based on at least one modification threshold.

17. A system for performing capacity planning services, comprising:
a client; and
a capacity planning (CP) manager, comprising a processor and memory, programmed to:
obtain a current CP state from the client;
in response to obtaining the current state:
select an action based on the current CP state;
provide the action to the client, wherein the client performs the action;
in response to providing the action:
obtain a new CP state and a headcount associated with the action;
calculate a reward based on the headcount and a reward formula;
store the current CP state, the action, the new CP state, and the reward as a learning set in storage comprising a plurality of learning sets;
perform a learning update using a portion of the plurality of learning sets to generate an updated actor, an updated critic, an updated target actor, and an updated target critic;
select a second action based on a second current CP state using the updated actor; and
initiate performance of the second action by the client.

18. The system of claim 17, wherein selecting the action based on the current CP state comprises applying noise and the actor to the current CP state.

19. The system of claim 18, wherein performing a learning update using a portion of the plurality of learning sets comprises:
randomly sampling the learning sets to obtain the portion of the learning sets;
updating the critic based on the portion of the learning sets;
updating the actor based on the portion of the learning sets; and
performing an incremental update of the target actor and the target critic.

20. The system of claim 17, wherein the reward formula is configurable.
